(19) United States
(12) Patent Application Publication
(10) Pub. No.: US 2013/0080885 A1
(43) Pub. Date: Mar. 28, 2013

(54) Systems and Methods For Use In Populating Information Into A Document

(71) Applicant: Ross Donnell Boyd, St. Louis, MO (US)

(72) Inventor: Ross Donnell Boyd, St. Louis, MO (US)

(73) Assignee: TRUQC LLC, St. Louis, MO (US)

(21) Appl. No.: 13/604,205

(22) Filed: Sep. 5, 2012

Related U.S. Application Data
(60) Provisional application No. 61/539,320, filed on Sep. 26, 2011.

(51) Int. Cl. G06F 17/00

(52) U.S. Cl. 715/255

(57) ABSTRACT

Systems, methods and devices for use in populating at least one document are disclosed. One example portable communication device includes a memory configured to store at least one document, the at least one document including a plurality of fields, the plurality of fields including a parameter field, an input device configured to receive at least one input from a user, a communication device configured to receive a measurement provided from a sensor disposed at the job site, and a processor coupled to the memory and the communication device. The processor is configured to automatically populate the parameter field with the measurement received from the sensor disposed at the job site, and is configured to receive the at least one input and to populate another one of the plurality of fields based on the at least one input.

### CROSS-REFERENCE TO RELATED APPLICATIONS

This application claims priority to Provisional Patent Application No. 61/539,320 filed Sep. 26, 2011, which is hereby incorporated by reference in its entirety.

### FIELD

The present disclosure relates generally to systems and methods for use in populating at least one document.

### BACKGROUND

This section provides background information related to the present disclosure and is not necessarily prior art.

During various types of processes, including, for example, construction processes and manufacturing processes, documentation is often maintained. The documentation may be maintained, for example, to provide evidence of conformance to one or more industrial and/or safety standards. Such documentation is generally completed by employees of a construction company or a manufacturing company on the job site through manually entering information, as dictated by the particular documentation. For example, weekly reports are completed on a weekly basis, while daily reports are completed on a daily basis. Regardless of the interval with which documents are completed, the documentation is often completed and delivered to a central repository for storage, so that the documentation may be retrieved upon request by customers and/or other inspecting party. These known systems create storage and transportation issues as documents must be transported from a remote job site to a central repository for approval. Additionally, the known systems allow an employee to manipulate data that must adhere to standards set forth.

### SUMMARY

This section provides a general summary of the disclosure, and is not a comprehensive disclosure of its full scope or all of its features.

In one embodiment, a portable communication device is provided. The portable communication device includes a memory configured to store at least one document, the at least one document including a plurality of fields, the plurality of fields including a parameter field, an input device configured to receive at least one input from a user, a communication device configured to receive a measurement provided from a sensor disposed at the job site, and a processor coupled to the memory and the communication device. The processor is configured to automatically populate the parameter field with the measurement received from the sensor disposed at the job site, and is configured to receive the at least one input and to populate another one of the plurality of fields based on the at least one input.

In another embodiment, one or more non-transitory computer-readable storage media having computer-executable instructions embodied thereon is provided. When executed by a controller, the computer-executable instructions cause the controller to display at least one document, the at least one document including a plurality of fields, the plurality of fields including a parameter field, receive at least one input from a user by a portable communication device, and receive, by the portable communication device, a measurement provided from a sensor disposed at the job site. The computer-executable instructions also cause the controller to automatically populate the parameter field with the measurement received from the sensor disposed at a job site, and populate another one of the plurality of fields based on the at least one input.

In another embodiment, a document administration system is provided. The document administration system includes a host server, wherein the host server includes a processor and a memory configured to store at least one document, a portable communication device communicatively coupled to the host server and configured to populate at least one of a plurality of fields within the at least one document, and a sensor communicatively coupled to the portable communication device, the sensor configured to record a measurement and transmit the measurement to the portable communication device, such that the communication device automatically populates a field of the plurality of fields within the at least one document.

The features, functions, and advantages that have been discussed can be achieved independently in various embodiments or may be combined in yet other embodiments, further details of which can be seen with reference to the following description and drawings.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a block diagram of an exemplary computing device.

FIG. 2 is a block diagram of an exemplary document administration system for use with the computing device shown in FIG. 1.

FIG. 3 is an exemplary interface for use in receiving at least one credential from a user using the system shown in FIG. 2.

FIG. 4 is an exemplary interface for use in displaying different types of documents to a user using the system shown in FIG. 2.

FIG. 5 is another exemplary interface for creating a document using the system shown in FIG. 2.

FIGS. 6-13 are exemplary interfaces including a daily inspection report using the system shown in FIG. 2.

FIG. 14 is an exemplary interface including a file cabinet aspect of the administration application of FIG. 4.

FIG. 15 is another exemplary interface including the file cabinet of FIG. 14, having a list of documents.

FIG. 16 is another exemplary interface including the file cabinet of FIG. 14 displaying previously submitted documents.

FIG. 17 is another exemplary interface including the file cabinet of FIG. 14 with a share button selected.

FIG. 18 is another exemplary interface including the file cabinet of FIG. 14 with an email option selected for one or more documents.

FIG. 19 is an exemplary administrative interface including a draft document aspect of an administration application using the system shown in FIG. 2.

FIG. 20 is another administrative interface including the file cabinet of FIG. 14 with an add document option selected.

FIGS. 21 and 22 are exemplary administrative interfaces for controlling the attributes of an exemplary inspection report using the system shown in FIG. 2.

FIGS. 23 and 24 are exemplary interfaces for a “toolbox talk” report using the system shown in FIG. 2.

### DETAILED DESCRIPTION

The subject matter described herein relates to electronically populating a document, such as, for example an inspection report, through use of a portable communication device. And, more particularly, the subject matter described herein relates to automatically populating, at the portable communication device, the document with one or more measurements received from a sensor in communication with the portable communication device.

As used herein, an element or step recited in the singular and proceeded with the word “a” or “an” should be understood as not excluding plural elements or steps unless such exclusion is explicitly recited. Furthermore, references to “one embodiment” of the present invention or the “exemplary embodiment” are not intended to be interpreted as excluding the existence of additional embodiments that also incorporate the recited features.

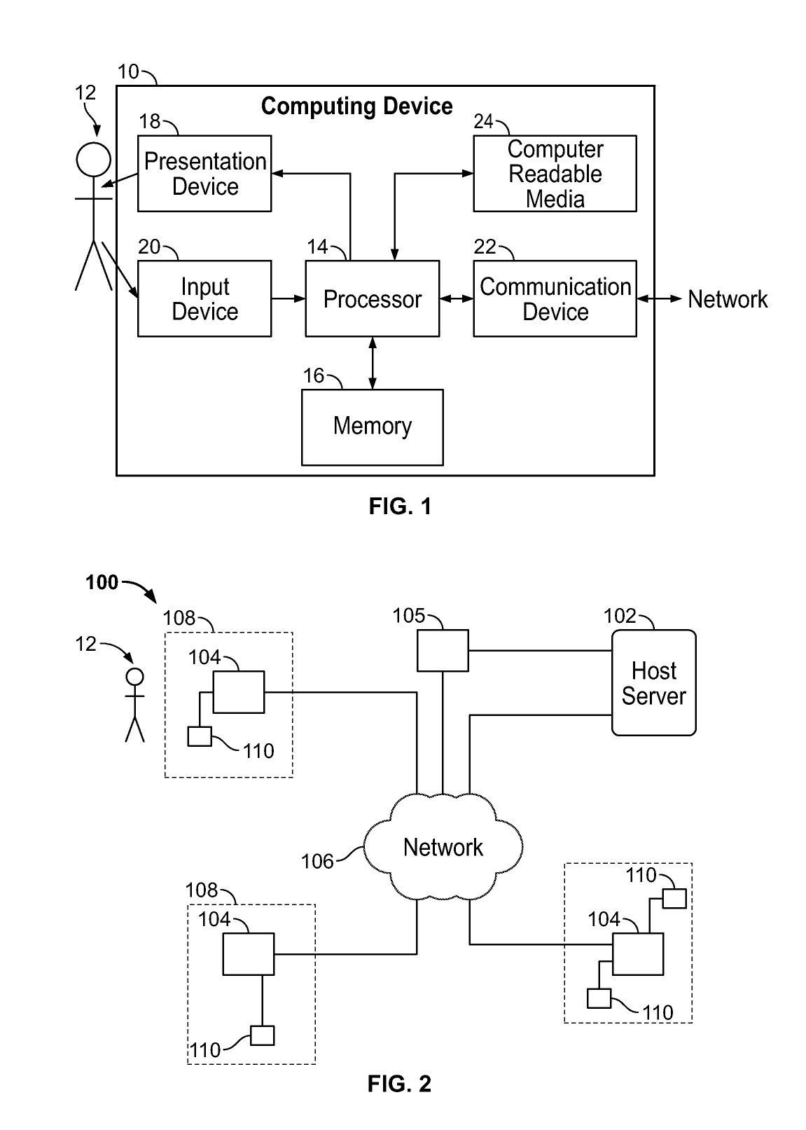

FIG. 1 is a block diagram of an exemplary computing device 10 that may be used to automatically populate a shared document. In the exemplary embodiment, computing device 10 includes a memory 16 and a processor 14 that is coupled to memory 16 for executing programmed instructions. Processor 14 may include one or more processing units (e.g., in a multi-core configuration). Computing device 10 is programmable to perform one or more operations described herein by programming memory 16 and/or processor 14. For example, processor 14 may be programmed by encoding an operation as one or more executable instructions and providing the executable instructions in memory 16.

Processor 14 may include, but is not limited to, a general purpose central processing unit (CPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer-readable medium including, without limitation, a storage device and/or a memory device. Such instructions, when executed by processor 14, cause processor 14 to perform at least a portion of the methods described herein. The above examples are exemplary only, and thus are not intended to limit in any way the definition and/or meaning of the term processor.

Memory 16, as described herein, is one or more devices that enable information such as executable instructions and/or other data to be stored and retrieved. Memory 16 may include one or more computer-readable media, such as, without limitation, dynamic random access memory (DRAM), static random access memory (SRAM), a solid state disk, and/or a hard disk. Memory 16 may be configured to store, without limitation, multiple inspection reports, measures from sensors, credential information, and/or any other type of data suitable for use with the methods and systems described herein.

In the exemplary embodiment, computing device 10 includes a presentation device 18 that is coupled to processor 14. Presentation device 18 outputs by, for example, displaying, printing, and/or otherwise outputting information such as, but not limited to, documents, interfaces, warnings, videos, photos, and/or any other type of data to a user 12. For example, presentation device 18 may include a display adapter (not shown in FIG. 1) that is coupled to a display device, such as a cathode ray tube (CRT), a liquid crystal display (LCD), a light-emitting diode (LED) display, an organic LED (OLED) display, and/or an “electronic ink” display. In some embodiments, presentation device 18 includes more than one display device. In addition, or in the alternative, presentation device 18 may include a printer.

In the exemplary embodiment, computing device 10 includes an input device 20 that receives input from user 12. For example, input device 20 may be configured to receive input, selections, and/or any other type of inputs from user 12 suitable for use with the methods and systems described herein. In the exemplary embodiment, input device 20 is coupled to processor 14 and may include, for example, a keyboard, a pointing device, a mouse, a stylus, a touch sensitive panel (e.g., a touch pad or a touch screen), and/or an audio input device. Further, in various exemplary embodiments, a touch screen, such as that included in a tablet computing device (e.g., iPad®) or similar portable communication device, functions as both presentation device 18 and input device 20.

In the exemplary embodiment, computing device 10 includes one or more communication device 22 coupled to memory 16 and/or processor 14. Communication device 22 is coupled in communication with a device spaced apart from computing device 10, such as a sensor or another computing device 10. For example, communication device 22 may include, without limitation, a wired network adapter, a wireless network adapter, a Bluetooth adapter, and/or a mobile telecommunications adapter. In at least one embodiment, computing device 10 includes processor 14 and one or more communication devices 22 incorporated into or with processor 14. In some embodiments, communication device 22 may be a network adapter, such as a ZigBee adapter, a Bluetooth adapter, and/or another long-range or short-range wireless network adapter. While communication device 22 is illustrated as incorporated with processor 14, it should be appreciated that communication device 22 (or another communication device) may be separate from processor 14 and/or engage processor 14. In one embodiment, communication device 22 includes a dongle, such as a ZigBee dongle, which is configured to plug into a standard computing device, such as an iPad®, to provide computing device 10 to provide ZigBee communication functionality between processor 14 and another device (such as another computing device 10 and/or a sensor described below). In another embodiment, communication device 22 includes a Bluetooth low energy (BLE) or Bluetooth 4.0 adapter. Further, communication device 22 may include a network adapter (e.g., internal to the iPad®) to communicate with a wide area network (WAN).

Instructions for operating systems and applications are located in a functional form on non-transitory memory 16 for execution by processor 14 to perform one or more of the processes described herein. These instructions in the different embodiments may be embodied on different physical or tangible computer-readable media, such as memory 16 or another memory, such as a computer-readable media 24, which may include, without limitation, a flash drive, CD-ROM, thumb drive, floppy disk, etc. Further, instructions are located in a functional form on non-transitory computer-readable media 24, which may include, without limitation, a flash drive, CD-ROM, thumb drive, floppy disk, etc. Computer-readable media 24 is selectively insertable and/or removable from computing device 10 to permit access to and/or execution by processor 14. In one example, computer-readable media 24 includes an optical or magnetic disc that is inserted or placed into a CD/DVD drive or other device associated with memory 16 and/or processor 14. In some instances, computer-readable media 24 may not be removable.

FIG. 2 illustrates an exemplary document administration system 100. In the exemplary embodiment, document administration system 100 includes a host server 102 and a plurality of portable communication devices 104. Portable communication device 104 may include, without limitation, smartphones, personal digital assistants (PDAs), mobile network devices, mobile handheld devices, and/or tablet computing devices (e.g., an iPad® device), etc. It should be appreciated that each of host server 102 and portable communication devices 104 are examples of computing devices 10.

Each portable communication device 104 is coupled to host server 102 through a network 106. In the exemplary embodiment, network 106 is a wide area network (WAN). In other embodiments, network 106 may include, without limitation, the Internet, an intranet, a local area network (LAN), a wide area private network, a wide area public network, a mobile network, a virtual network, and/or another suitable network for communicating data between host server 102, another portable communication device 104, a sensor, and/or other computing devices. As shown, each portable communication device 104 is associated with a job site 108 and a user 12 on job site 108. In one example, user 12 may include a foreman, a laborer, an inspector, and/or another person suitable to operate and/or interface with portable communication device 104. Further, job site 108 may include various types of job sites for construction, manufacturing, assembly-line, demolition, coating, painting, repair, excavation, hauling, carpentry, installation, electrical, and/or plumbing, etc.

In the exemplary embodiment, each job site 108 includes one or more sensors 110, which may include a computing device 10. Portable communication device 104 is configured to communicate with sensor 110 through communication device 22. Specifically, in the exemplary embodiment, sensor 110 is configured to communicate with portable communication device 104 through Bluetooth, ZigBee, and/or another wireless protocol. In one embodiment, BLE is utilized in communication device 22 such that communications device 22 is configured to communicate with multiple sensors 110 sensors simultaneously. In at least one embodiment, sensor 110 is coupled to portable communication device 104 through a wired connection. In still another embodiment, sensor 110 is configured to communicate with portable communication device 104 through wide area network 106. Sensor 110 is configured to provide a signal to portable communication device 104 indicative of a measurement taken thereby. The measurement may include, for example, temperature, pressure, humidity, coating holiday or defects, dew point, material characteristics, surface characteristics, weather conditions, coating, paint, powder, and/or film thickness, density, drying time, elasticity, hardness, salt content, lead content, ultrasonic multi-layer detection, viscosity, depth, wall thickness, adhesion, or other parameters related to job site 108. It should be appreciated that sensor 110 may be configured to communicate with portable communication device 104 through one or more other communication techniques, such as, for example, radio frequency identification (RFID), Wi-Fi, cellular, satellite, radio, microwave, and/or infrared, etc.

In the exemplary embodiment, one or more of portable communication devices 104 and host server 102 is configured to provide an administration application for, among other things, coordinating documentation between job site 108 and host server 102. The administration application may be executed by host server 102 and/or one or more of portable communication devices 104 to display one or more of the plurality of interfaces at portable communication device 104 to user 12. Further, in at least one embodiment, administration application may be executed to provide interfaces for presentation to user 12 at a workstation 105, which includes a computing device 10, but not a portable communication device.

In the exemplary embodiment, the document is stored in memory 16 of host server 102. Such documentation may be accessed by or copied to portable communication devices 104. When a document is created, edited, and/or deleted at portable communication device 104, portable communication device 104 occasionally syncs the document with the same document stored at host server 102. In one embodiment, portable communication device 104 stores a document locally and then syncs the document with the same document stored at host server 102 at a predetermined time. Alternatively, portable communication device 104 syncs the document with the same document stored at host server 102 without storing the information locally. Syncing may occur, for example, in 5 minutes intervals, in 15 minute intervals, in response to a user command, according to a schedule, whenever a change is made (providing real-time updates), or at any other suitable time. In this manner, documentation for job site 108 is retained at a common location, such as host server 102, and may be accessed by a number of users 12 through one or more portable communication devices 104 and/or workstations 105.

Accordingly, the administration application permits documents to be completed and/or stored consistent with one or more industry standards and/or requirements. For example, in the coating industry, the administration application may store documentation related to, for example, SSPC (Society for Protective Coatings) contractor certifications QP1, QP2, QS1.

The operation of the various components of the system will be better understood by reference to the following exemplary administration application embodiment. It should be understood, however, that the description is provided to illustrate the operation of document administration system 100, and components included therein. It is also noted that document administration system 100 can be used in a variety of different industries to administer documentation related to one or more job sites. Such industries may include, without limitation, construction, manufacturing, assembly-line, demolition, coating, painting, repair, excavation, hauling, carpentry, installation, electrical, and/or plumbing, etc. For ease of illustration, exemplary interfaces 200-280 of the administration application related to the use of system 100 in maintaining documentation for the coating industry. The concepts disclosed herein, however, can be implemented in other types of industries without departing from the scope of the present disclosure.

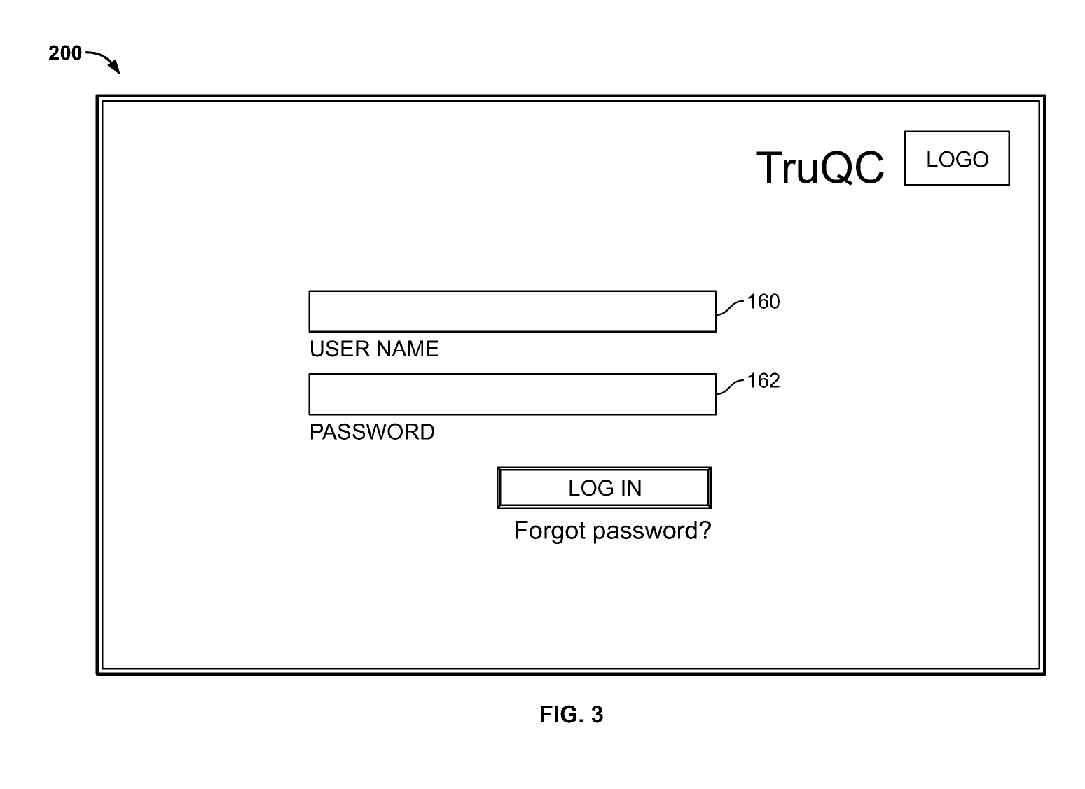

A plurality of exemplary interfaces is illustrated in FIGS. 3-24. The exemplary interfaces are stored at host server 102 and/or portable communication devices 104. In the exemplary embodiment, the plurality of interfaces is provided by processor 14 to be displayed to user 12 at presentation device 18. While interfaces consistent with the present disclosure may be provided for presentation to any type of computing device 10, interfaces 200-262 are described as provided for presentation at presentation device 18 of portable communication device 22. In at least one embodiment, such interfaces may be displayed at workstation 105. It should be further appreciated that various other interfaces may be provided for presentation to user 12, potentially depending on the type of documentation managed by the administration application. Accordingly, interfaces 200-262 are merely exemplary and should not be understood to limit the scope of the present disclosure.

FIG. 3 illustrates an exemplary interface 200 for use in receiving at least one credential from the user. In the exemplary embodiment, interface 200 includes a log-in field to receive a username 160 and password 162 from user 12. Different credentials, such as biometric information, may be provided by each user 12, thereby enabling the administration application to distinguish between different users 12. Further, credentials presented to interface 200 may be utilized to grant different permissions, provide different information and/or direct user 12 to a different aspect of the administration application. In one example, when a foreman user 12 provides credentials to interface 200, the foreman user 12 may be granted access to only job sites 108 to which foreman user 12 is assigned. In this manner, the administration application inhibits foreman user 12 from viewing inspection reports or other documentation associated with job sites to which foreman user 12 is not assigned. In another example, a foreman supervisor user 12 may be granted access to job sites 108 assigned to multiple foreman users 12 under his supervision.

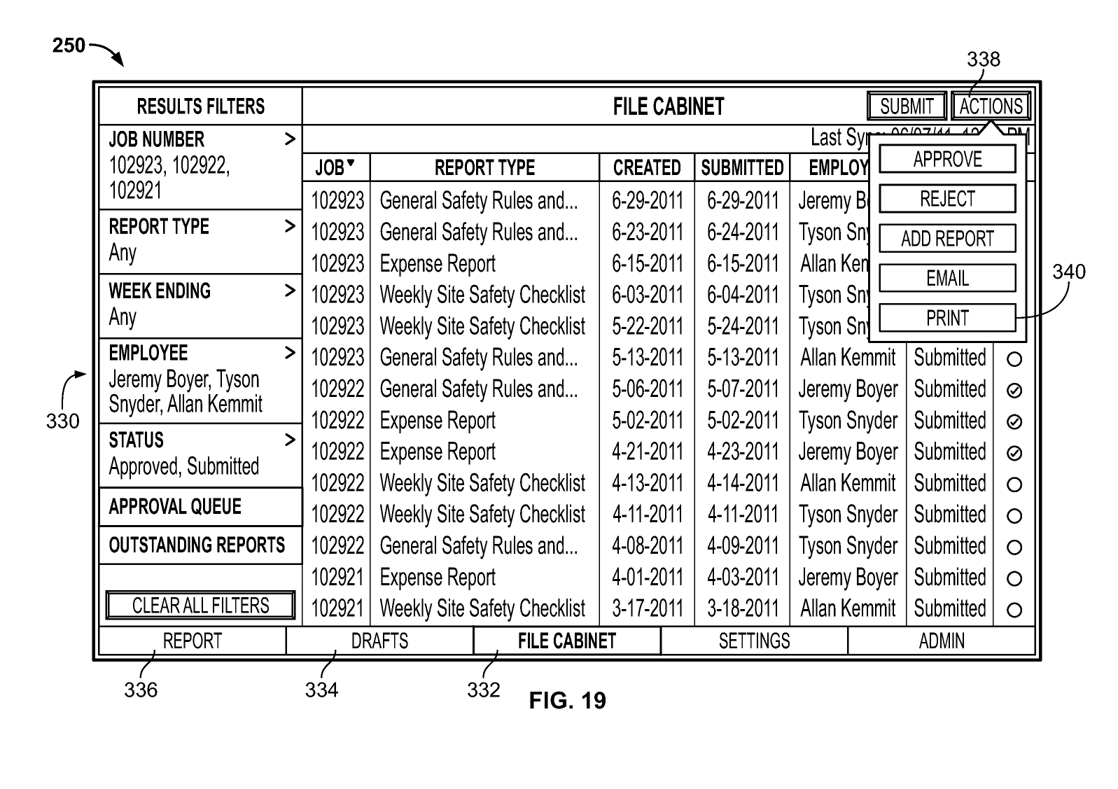

Additionally, or alternatively, credentials are used in some embodiments to implement permissions list, which indicates which users 12 are able to access and/or edit which documents and/or job sites 108. Further, credentials may be provided by a user to access an administrative module of the administration application to manage users 12 as indicated below with reference to interfaces 250-262 of FIGS. 19-22. Further still, potentially depending on the types of computing device 10, only one user 12 may be logged into the administration application from one computing device 10 at one time.

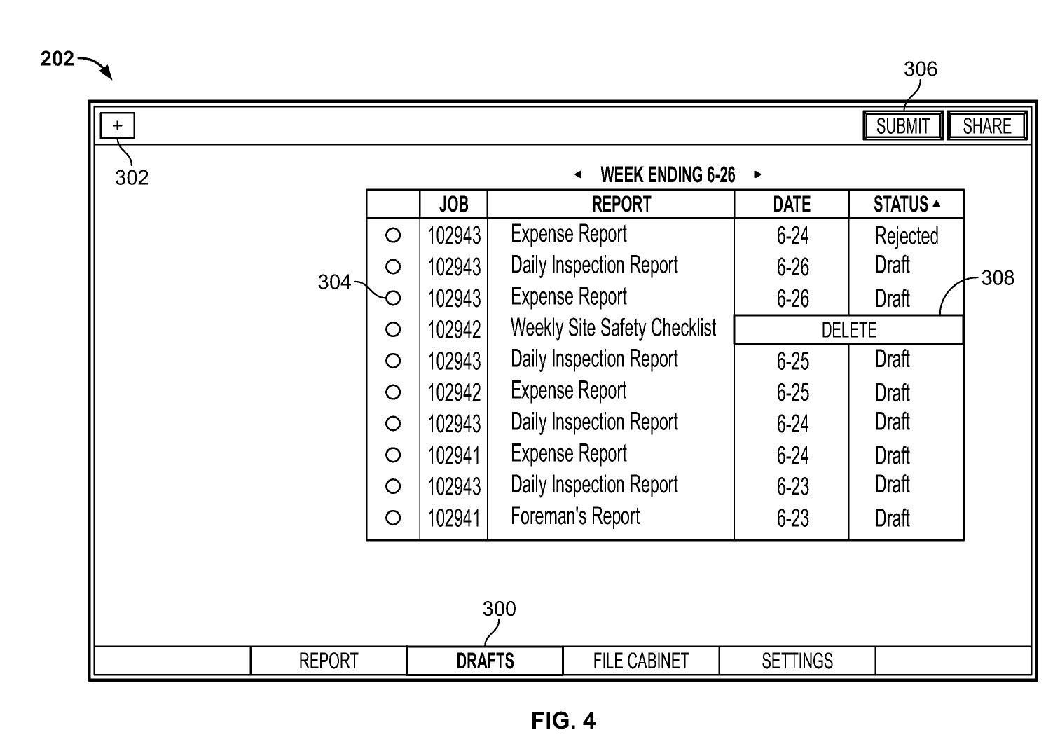

FIG. 4 illustrates an exemplary interface 202 for use in displaying different types of documentation to user 12. Such documents may include, for example, daily inspection reports, expense reports, foreman's report, weekly site safety checklist, etc. As should be apparent, other types of documents may be included in the administration application, potentially depending on the type of industry for which administration application is provided. In the exemplary embodiment, the documents are organized by job site number. In other embodiments, documents may be organized by, without limitation, report numbers, purchase order numbers, customers, customer numbers, customer names, products, project names, etc. One type of organization may be preferred depending on the use of the administration application. In one example, documents for managing construction documentation may be organized by job site number. In another example, documents for managing manufacturing documentation may be organized by purchase order number or product name.

Interface 202 further includes a status of the reports in the drafts tab 300. Documents under drafts tab 300 are to-be-completed by user 12. In the exemplary embodiment, the status of documents under drafts tab 300 may be draft (in need of completion) or rejected, if an administrator user 12 has reviewed and rejected the document. Other status designations may be included in other embodiments. From the drafts tab 300, user 12 may select any of the documents to view and/or edit. Additionally, user 12 may be permitted to select one or more of the documents through use of checked box 304 and/or submit each of the draft documents listed in interface 202 at button 306. Further, in exemplary interface 202, through use of a slide motion of touch screen presentation device 18, user 12 may select a document for deletion 308.

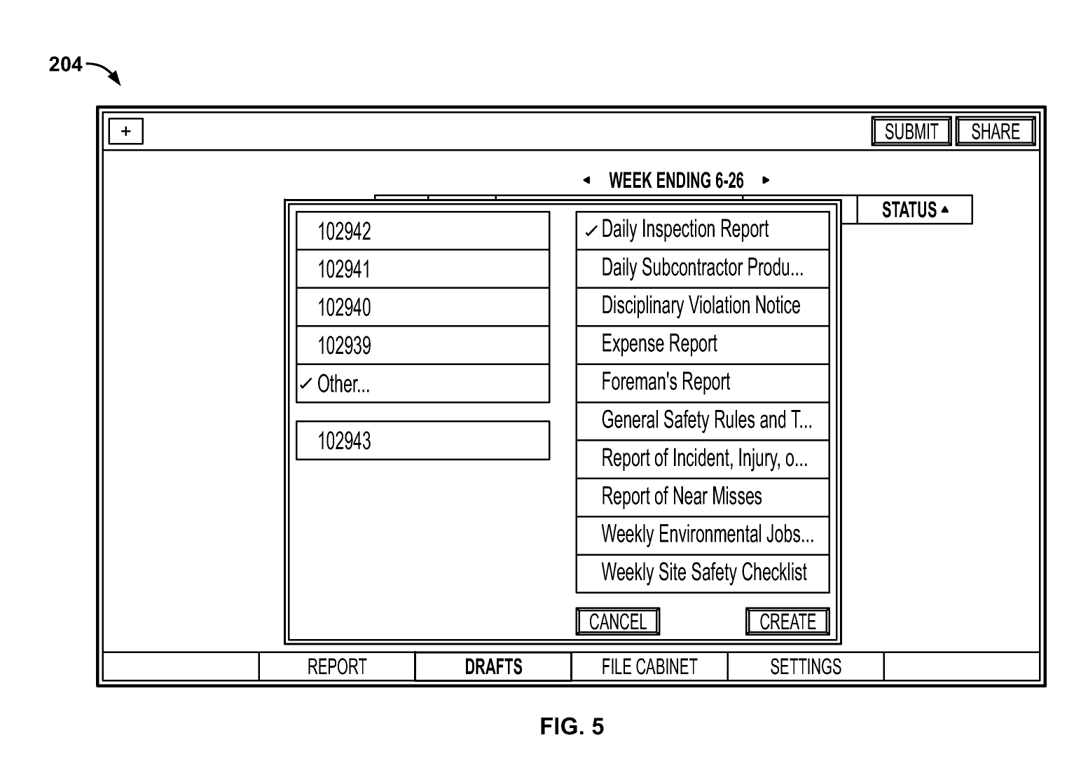

Moreover, addition button 302 further permits user 12 to add a document to interface 202. When user 12 selects addition button 302, exemplary interface 204 is provided for presentation to user 12 at portable communication device 104, as shown in FIG. 5. Within interface 204, user 12 is permitted to create one or more documents. In the exemplary embodiment, each document created is associated with job site 108. In other embodiments, one or more documents may be created and associated by, for example, report numbers, purchase order numbers, customers, customer numbers, customer names, products, project names, etc. Further, any number and/or type of document may be created through interface 204. In at least one embodiment, an administrator user 12 may limit the type of documents available to be created by foreman user 12. In one example, foreman user 12 for job site 108 may only be able to create and/or select from four different types of documents designated by supervisor user 12.

It is noted that administration application may be configured to display any one or more of the documents listed in interfaces 202 to user 12. For ease of illustration, exemplary interfaces 206-266 include content of a daily inspection report. One or more of the concepts disclosed therein, such as the types of fields and the manner in which fields are populated, however, may be applicable to any type of document administered by system 100.

Upon selection of the daily inspection report from interface 202, the administration application provides interfaces 206-266 to permit information to be populated into the daily inspection report. The information may include various types of information related to job site 108, aspects of a project and/or product at job site 108, user 12 linked to or supervising job site 108, and/or employees on job site 108, and/or other information relative to a daily inspection report, etc. Some of the fields are populated manually by user 12, while other fields are automatically populated from sensors 110 and/or logic included in one or more of interfaces 206-238. For example, interface 206 includes several fields, which are populated manually by user 12, by selecting the field to activate a keyboard, radio buttons, a scrolling picker, a numeric keyboard, a multi-select table, etc. Further, some fields may be completed based on entries of other fields. In several embodiments, various combinations of keyboards, radio buttons, scrolling pickers, auto-populates, numeric keyboards, multi-select tables (e.g., choosing an option from a list), and segmented control (e.g., choosing one option from several responses) may be included at fields in various interfaces to minimize and/or reduce the amount of typing by user 12 to populate the daily inspection report.

It should be appreciated that user 12 proceeds through the inspection report by selecting the section of the report to be populated in the left edge of interfaces 206-238. In this manner, user 12 is able to populate and/or edit multiple sections of the inspection report in whatever order may be efficient and/or preferred. In other embodiments, interfaces of an administration application may be provided for presentation to presentation device 18, such that information is populated in a specific order. Further, in the exemplary embodiment, when user 12 navigates away from a document, and later returns to that same document, the administration application returns user 12 to the last section of the document viewed and/or edited by user 12. As such, user 12 may navigate between multiple documents, without having to enter a document at an initial section and scrolling up/down to his place within the document.

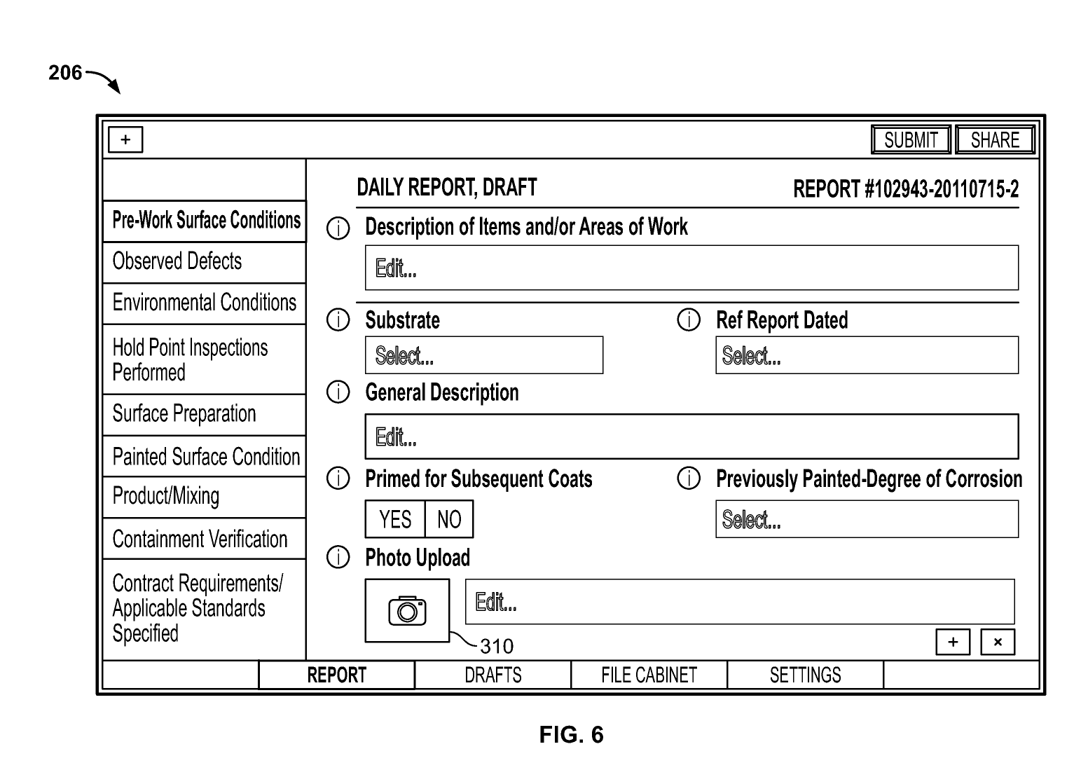

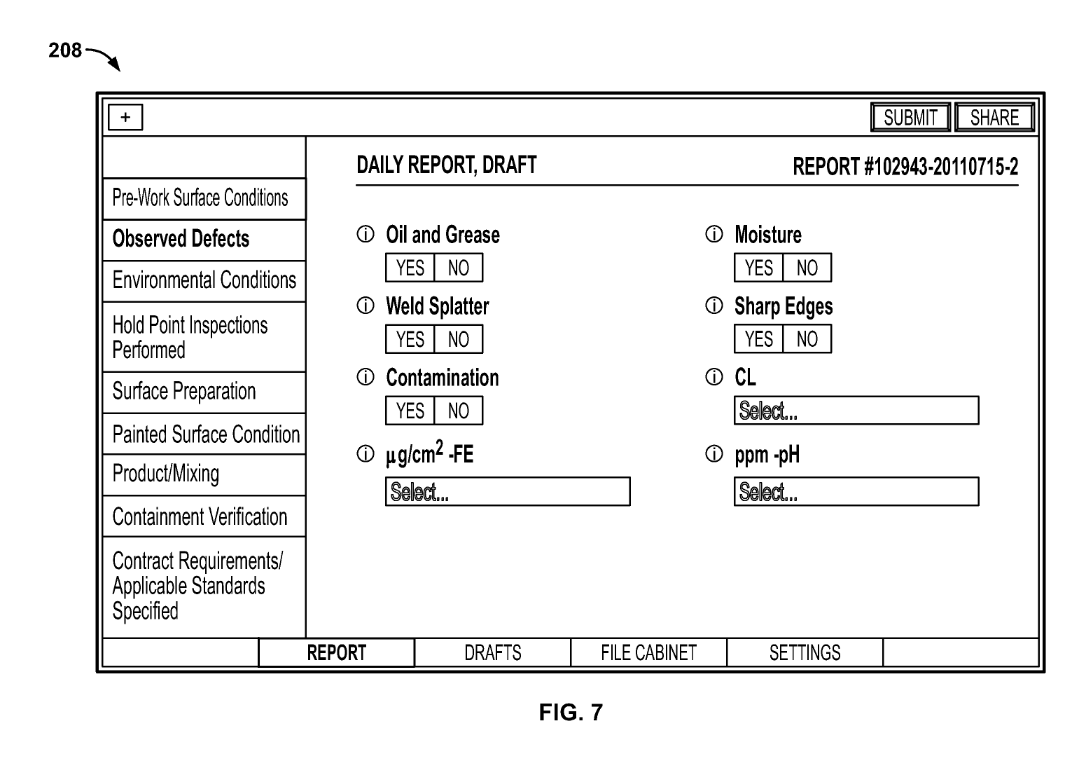

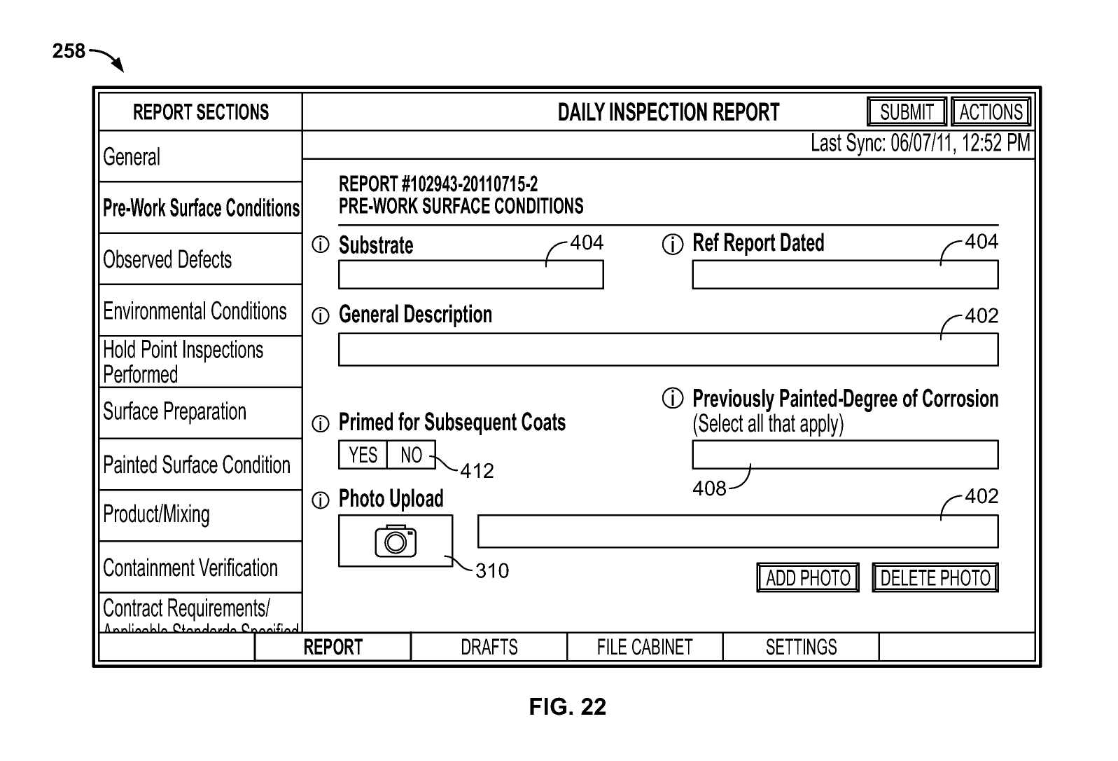

Referring to FIG. 6 and FIG. 7, exemplary interfaces 206 and 208 provide user the ability to populate fields in a document. In the exemplary embodiment, interface 206 provides user 12 the ability to capture pre-work conditions and interface 208 enables user 12 to input defects observed by user 12. Additionally, interface 206 includes a photo entry field 310. In such an interface, a photo capture input device 20 of portable communication device 104 is used by user 12 to capture a photo of pre-work surface conditions (in this example), which is included in the daily inspection report. Photo capture input device 20 is used to capture other types of information, such as, for example, a pre-surface work condition (FIG. 22), surface preparation TESTEX Tape, painted surface condition, coating product type, contaminant verification, non-conforming items or any other information suitably relayed as a picture, etc. When user 12 selects photo entry field 310, user 12 may be prompted to select between taking a photo with portable communication device 104 or recall a photo from memory 16 of portable communication device 104. In various embodiments, user 12 is permitted to include one or multiple photos at each photo entry field.

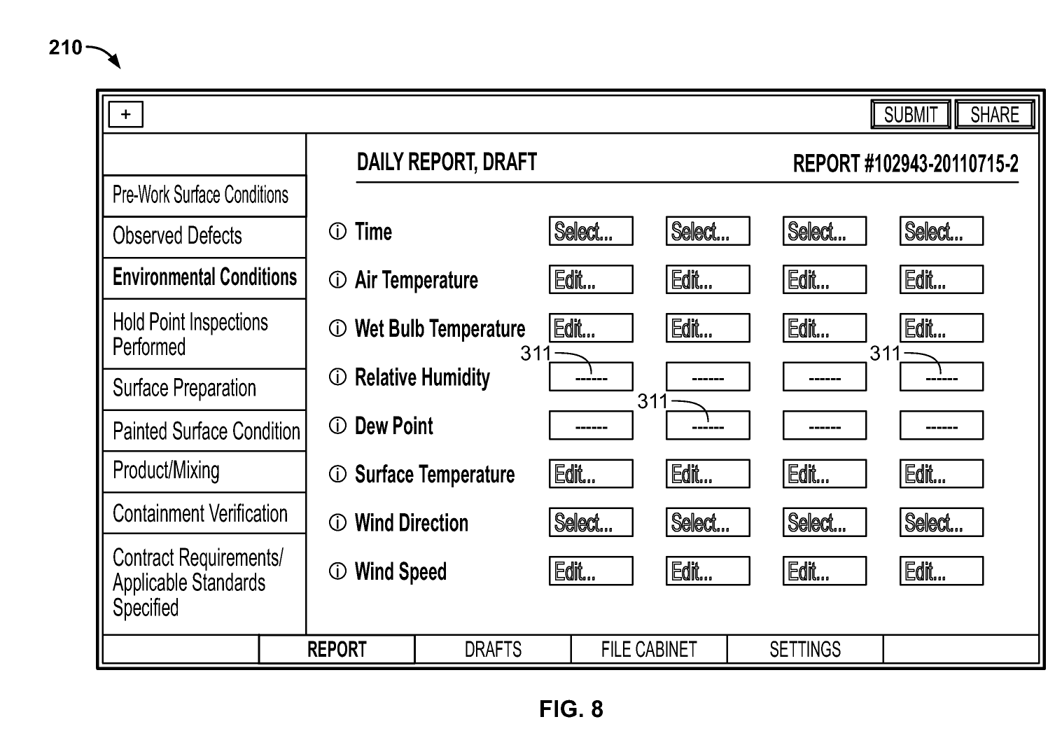

Moreover, several of interfaces 206-238 include auto-populate fields. As shown in FIG. 8, for example, interface 210 includes fields 311 configured to be auto-populated through use of sensor 110. More specifically, in this example, sensors 110 are positioned at job site 108 to take one or more measurements of weather conditions, such as temperature, humidity, dew point, surfaces temperature, wind direction, wind speeds, etc. When sensors 110 acquire the measurements, sensor 110 communicates the measurements to portable communication device 104 through one or more wired or wireless connections therebetween. In turn, portable communication device 104 automatically populates the measurements into appropriate parameter fields of the daily inspection report. In this manner, user 12 is not required or enabled to enter the measurements into interface 210.

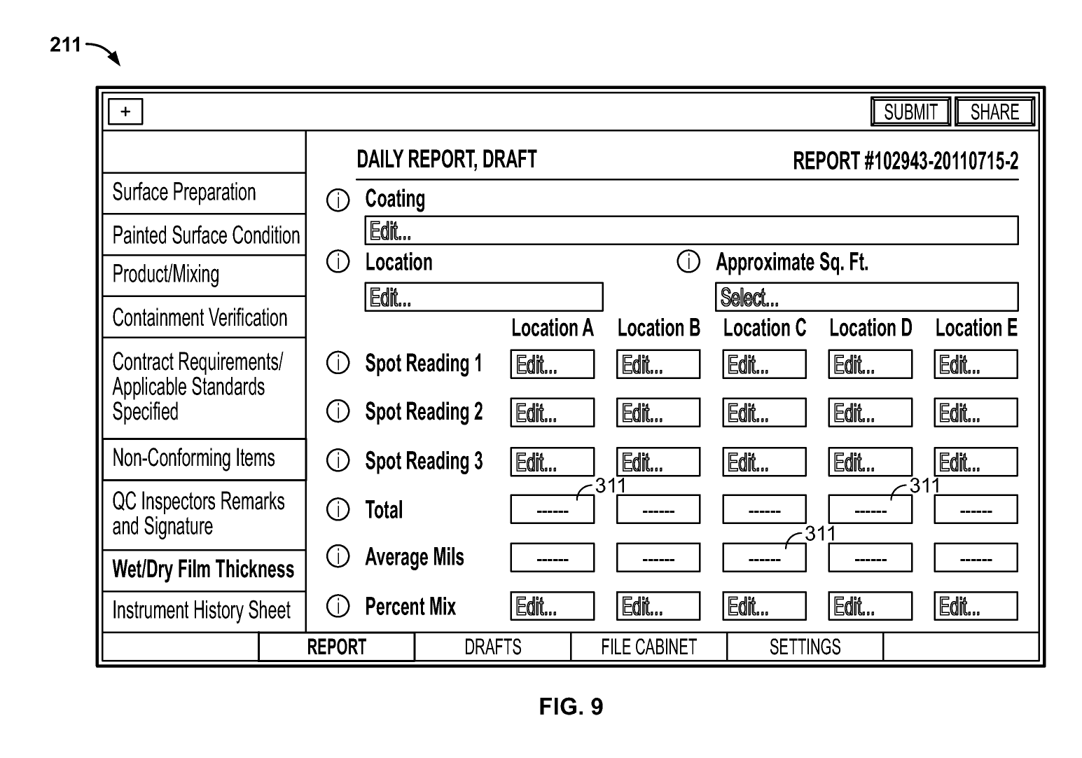

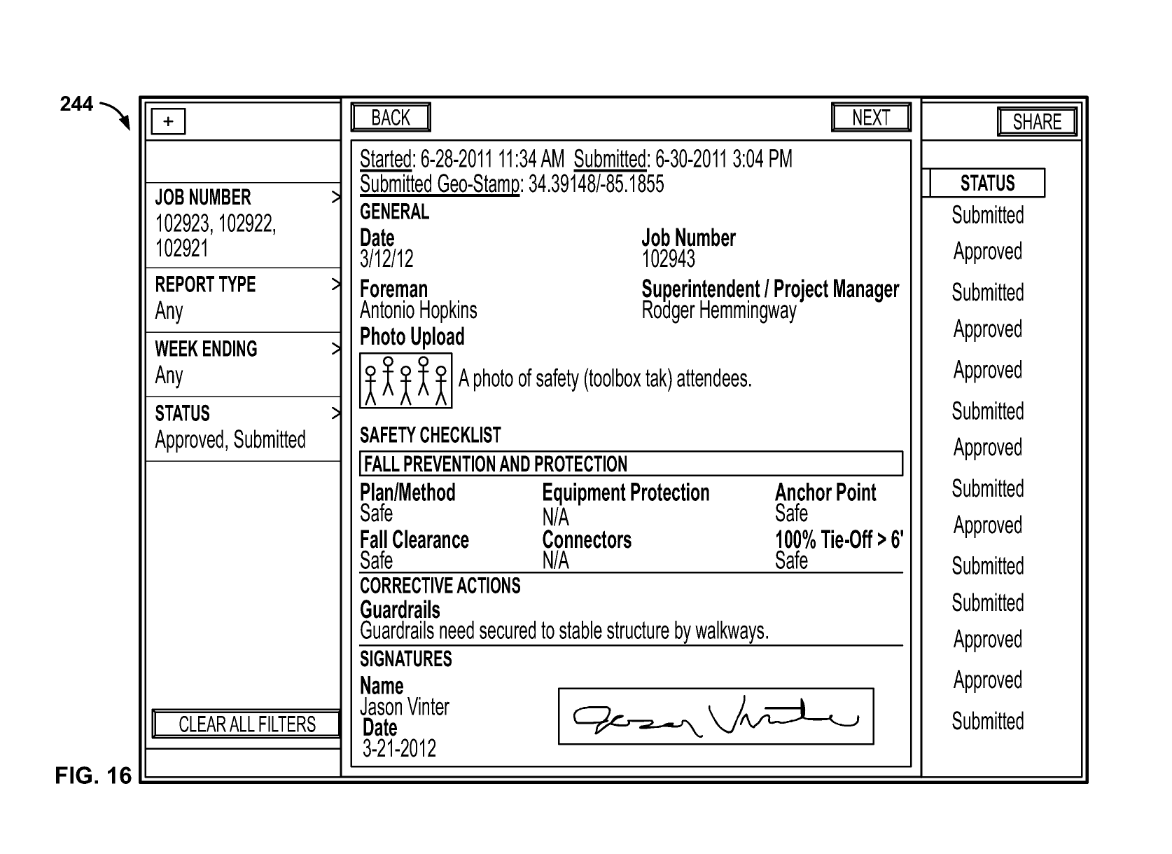

In addition to weather conditions, auto-populate fields may include various other types of information, which may be provided from sensor 110. Referring to FIG. 9, for example, a film thickness sensor 110 is provided to measure a thickness of a film or coating applied to a surface. In response to such a measurement, portable communication device 104 auto-populates the measurement into parameter fields 311 of interface 211. In at least one embodiment, auto-populate fields, such as the thickness measurement in interface 211, may be non-editable by user 12. Accordingly, in such an embodiment, administration application provides an objective method of recording a measurement, without permitting the user 12 to interpret and/or alter the measurement from sensor 110. Additionally, integrity and/or objectivity of manual data entered can be maintained using auto-populate fields to record a validation parameter that is entered into documents. The validation parameter can include, for example, but is not limited to, a time or time stamp, and/or a geographic location, as is seen on interface 244 of FIG. 16. The geographic location can be recorded using GPS or any other similar geographic locating technology. In one embodiment, when data is entered into a document by user 12, a field is automatically populated with verification information, for example, a time stamp and/or geographic location will provide details of when and where the data was entered.

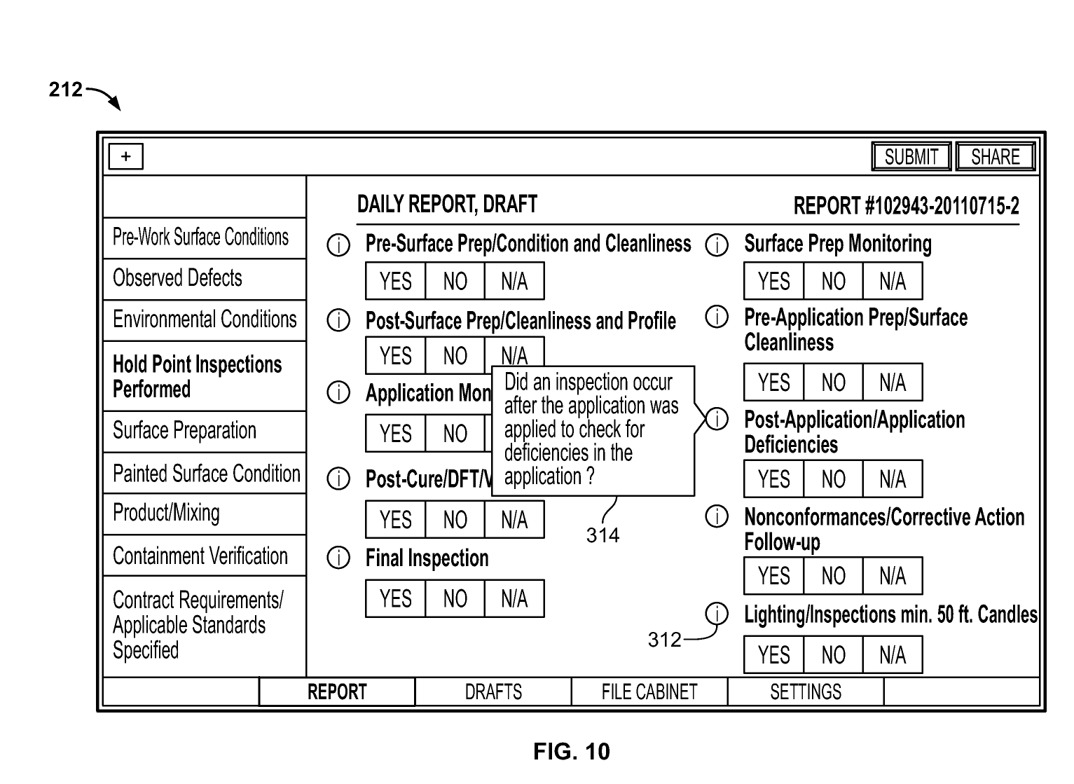

Referring to FIG. 10, interface 212 includes several fields related to hold point inspections. As shown, each field includes an information button 312 associated therewith. When user 12 interacts with interface 212, for example, but needs additional information to properly populate information into the field, user 12 may select information button 312 to activate an information panel 314. Information panel 314 may provide any type of information that may assist user 12 in populating the associated field with the appropriate information, such as, for example, industry standards. For example, in interface 212, information button 312 associated with a Post-Application field may provide information related to particular instructions, thereby assisting user 12 in populating the containment specified field appropriately.

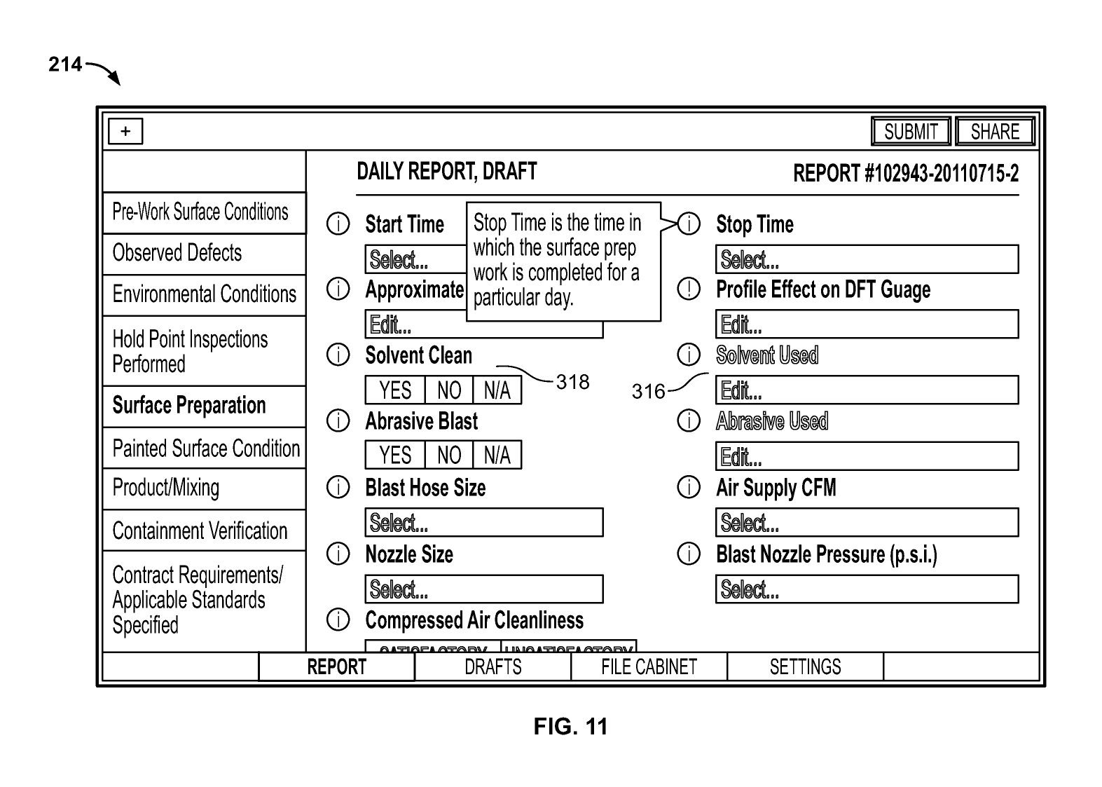

In the exemplary embodiment, fields in the inspection report of exemplary interfaces 206-238 is required, such that submission of the report without all fields completed may be inhibited by the administration application. In one embodiment, information may be required or optional. Additionally, several types of information may be dependent on other information in other fields. Referring to FIG. 11, for example, a field for providing a solvent used 316 may only be required when user 12 indicates a solvent clean was completed in field 318. In this exemplary interface 214, solvent used field 316 is grayed out (or deactivated) until user 12 indicates a solvent clean was completed in field 318. It should be appreciated that various types of information may be required based on the entry of other information. Exemplary interfaces contemplated herein may visually distinguish such fields in various manners to convey to user 12 that information is required, optional, or not required.

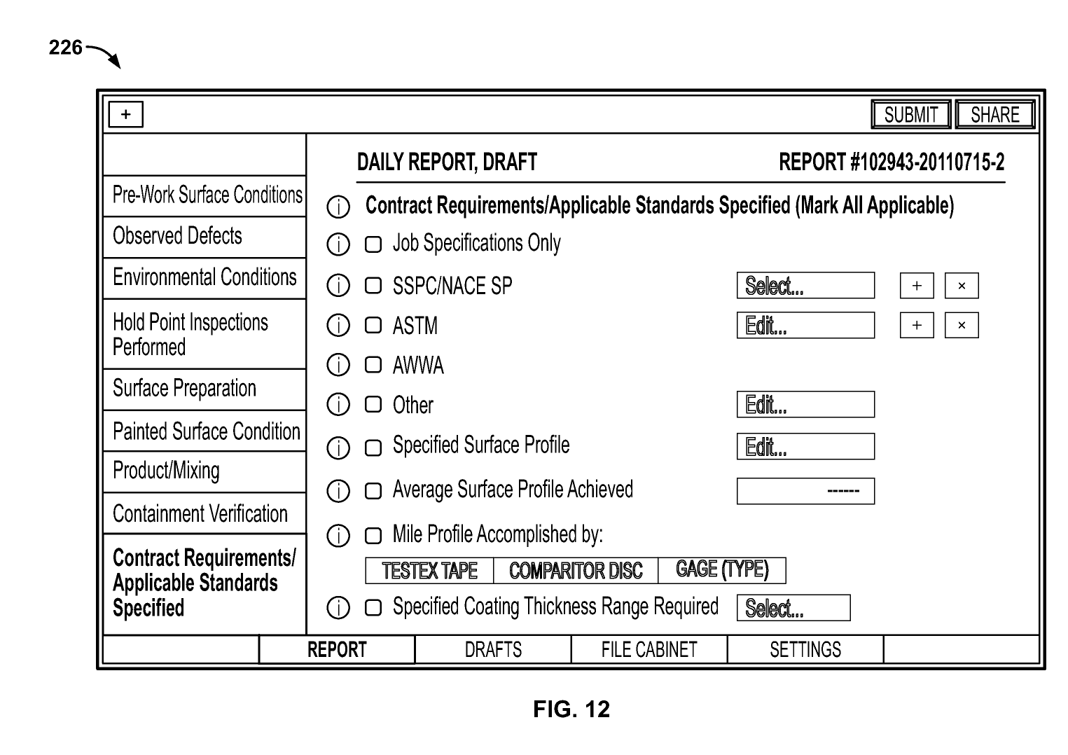

In the exemplary embodiment, information may be auto-populated into various fields of the inspection report based on set up of the report and/or information provided to other fields. Referring to FIG. 12, an inspection report may be a specific design for a particular type of job site 108. In such examples, the inspection report may be pre-populated with information related to standards and/or contract requirements as included in interface 226. Further, information may be auto-populated in the inspection report from memory 16 based on information populated into other fields of the inspection report. For example, when user 12 selects a job site 108 during the creation of a report, for example, processor 14 may auto-populate information from memory 16 related to job site 108 into the new report. Such information may include, for example, job site location, requirement parameters of job site 108, employee information, etc. Further, various fields may be auto-populated through one or more components of portable communication device 104. In one example, processor 14 in combination with communication device 22 provide GPS functionality, such that location information may be auto-populated into one or more fields of the inspection report.

Additionally, or alternatively, other information may be auto-populated into the inspection report through logic, by processor 14. In several embodiments, processor 14 may perform one or more calculations based on one or more fields populated by user 12 to auto-populate information into other fields. One such calculation may include, for example, adding two thicknesses of different coatings to provide a total thickness of the combined coatings.

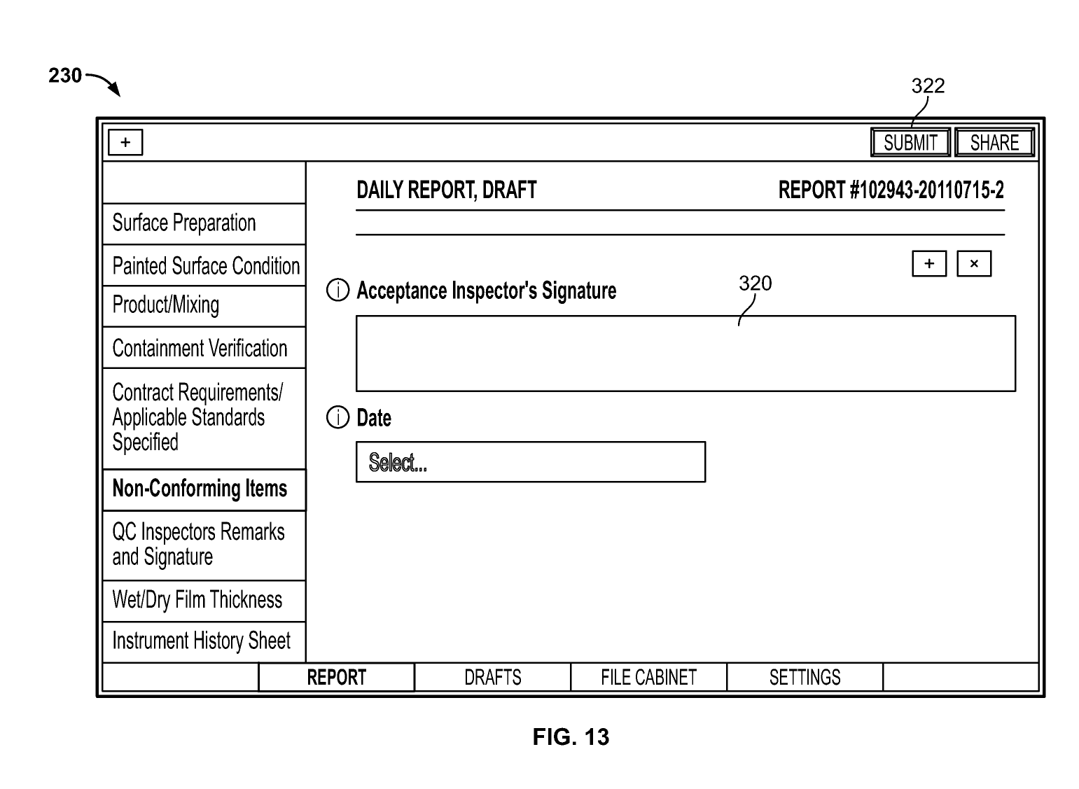

In the exemplary embodiment, when user 12 has completed the inspection report, a signature field 320, such as that shown on interface 230 of FIG. 13, is provided to receive an electronic signature from user 12, (e.g., an inspector or foreman), using a finger and/or a stylus type device for use with portable communication device 104. The signature of user 12 may be required on multiple interfaces within a single report. Upon completion of the document, the inspection report may be submitted to host server 102 for review and/or approval. In the exemplary embodiment, each of interfaces 206-238 includes a submit button 322. Upon selection of the submit button, processor 14 determines whether or not all required information in the inspection report has been populated. If the information is populated, portable communication device 104 indicates to host server 102 the inspection report is completed. In one or more embodiments, upon submission of the inspection report, portable communication device 104 transmits the entire inspection report to host server. In other embodiments, portable communication device 104 relies on an occasional sync function between host server 102 and portable communication device 104 to provided content of the inspection report to host server 102, which the report is submitted.

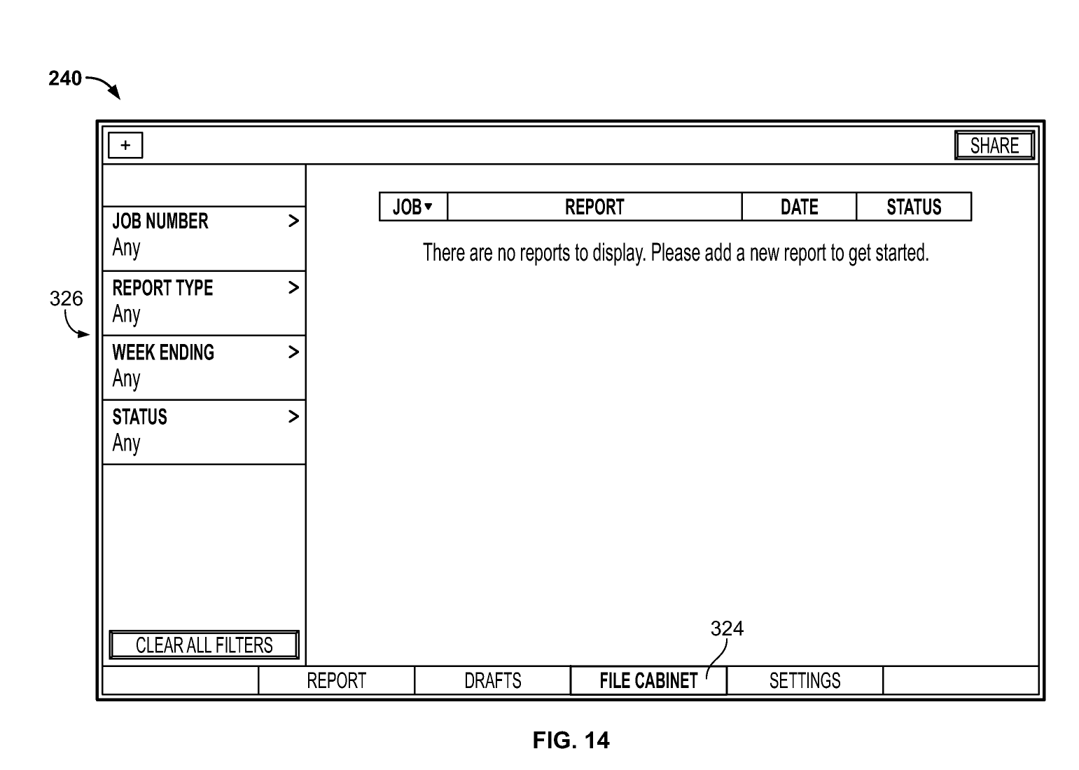

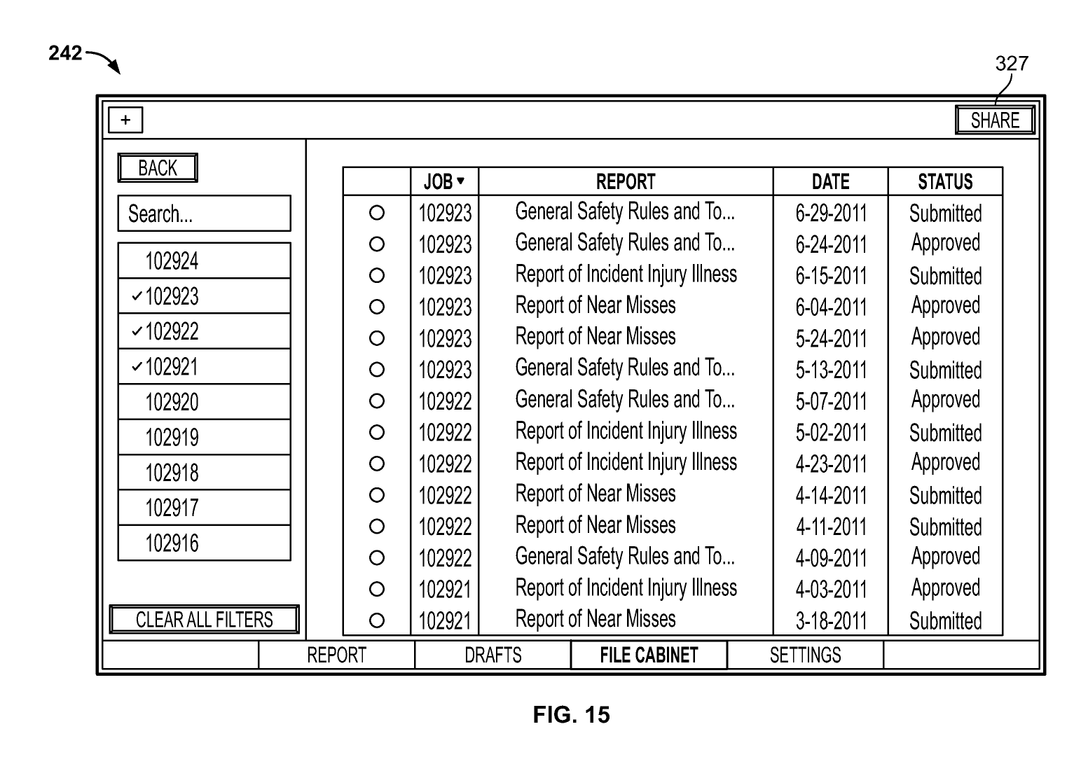

In the exemplary embodiment, administration application includes a file cabinet interface 240, provided by selecting file cabinet tab 324, shown in FIG. 14. Interface 240 permits user 12 to view previously submitted documents. As shown, documents may be located by filtering documents according to criteria 326, such as job number, report type, week ending (date), and/or status. It should be appreciated that documents in other file cabinet interface embodiment may be filterable according to a variety of criteria. Exemplary interface 242, shown in FIG. 15, illustrates the file cabinet upon selection of three job sites 108. Each of the documents associated with the three job sites 108 are included in the listing of document, which is navigable by dragging a finger up/down the presentation device 18. From interface 242, one or more of the documents may be selected and provided to be displayed. For example, interface 244 of FIG. 16 illustrates the display of a PDF version of one of the submitted daily reports for job site #102943. Accordingly, the file cabinet permits user 12 to view previously submitted documents.

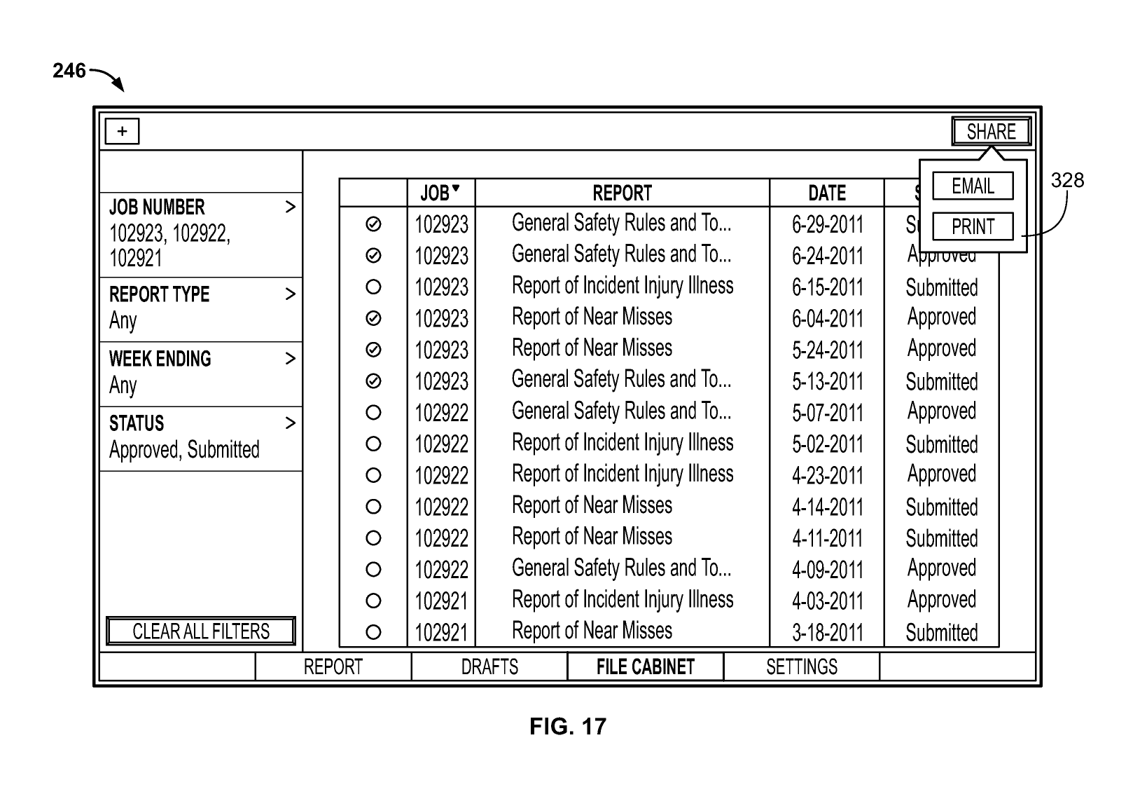

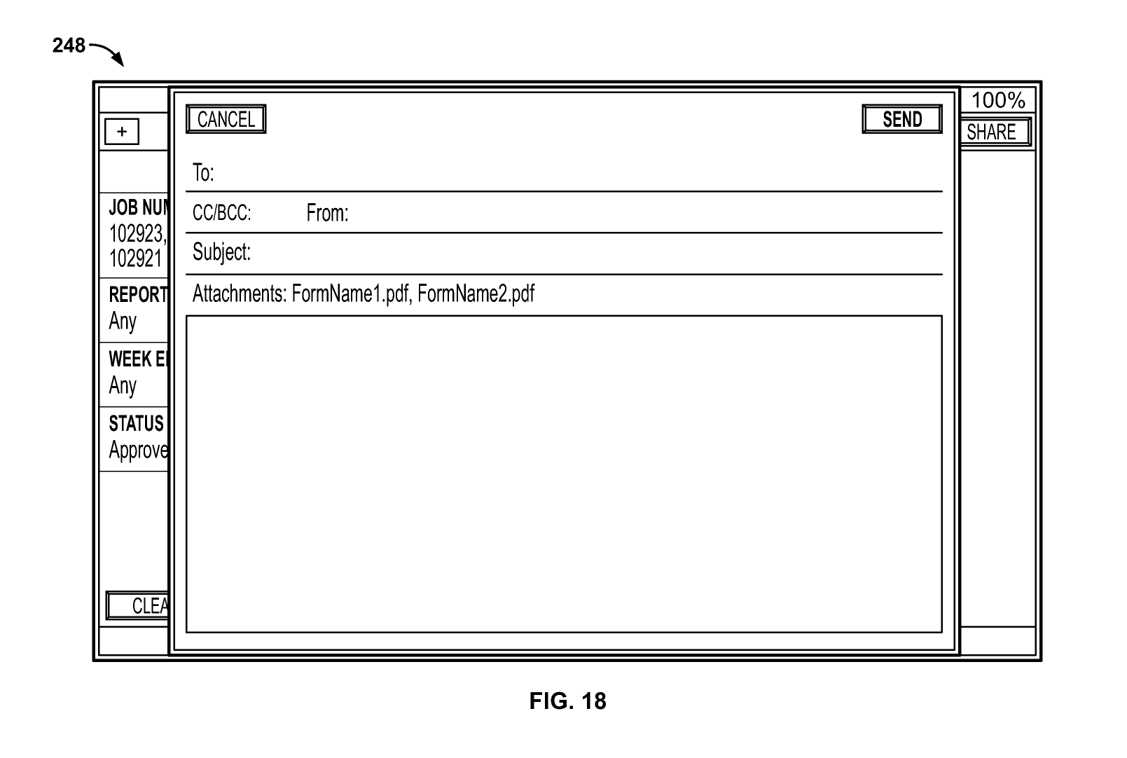

Further, documents may be shared through the file cabinet, and interface 242, by selecting share button 327. Upon picking one or more documents and selecting share button 327, a share panel 328 is provided for presentation, as shown in interface 246 of FIG. 17. From share panel 328, user 12 may select to email the documents or print the documents. Upon selection of the email option, an email is opened including the documents as attachments, as shown in exemplary interface 248 of FIG. 18. Additionally, or alternatively, when the print option is selected, the documents may be sent to a local or network printer to be printed.

As described above, user 12 may provide credential to access administration application as an administrator. In the exemplary embodiment, interfaces 250-262 provide part of the administrative module. Interface 250, of FIG. 19, includes a list of documents, which is filtered according to selection criteria 330. The criteria includes, for example, job number, report type, week ending, employee, status, approval queue and outstanding report. In the exemplary embodiment, file cabinet tab 332 permits the administrator user 12 to view documents, which have been submitted for approval by one or more users 12 from portable communication devices 104. Additionally, drafts tab 334 permits administrator user 12 to view reports, existing within the administration application, which have not been submitted. Further, a report tab 336 permits administrator user 12 to edit existing, but un-submitted document, similar to the exemplary editing and/or populating of the daily inspection report described above with reference to FIGS. 6-13.

Exemplary interface 250 includes an action button 338. Upon selecting one or more documents (i.e., indicated by check-circles) and selecting the action button 338, an action panel 340 is provided for presentation to administrator user 12 to approve, reject, add report, email, or print the selected documents. By permitting administrator user 12 to select multiple documents and select an action in this manner, the administration application permits administrator user 12 to take action on multiple documents at one time, potentially providing efficiency over acting on one document at a time. It should be appreciated that more or less actions may be available to administrator user 12 in other administration application embodiments.

In the exemplary embodiment, administrator user 12 approves or rejects each document submitted by another user 12, such as a foreman user 12 at job site 108. If the document is approved, the document is maintain in memory 16 of host server 102 to be recalled in the future, if need. In one embodiment, after a document is approved, the document becomes non-editable and stored in memory 16 to maintain the integrity of data entered into the document. Alternatively, in the exemplary embodiment, if the document is rejected, the document re-appears under the drafts tab of interface 202 for the submitting user 12, thereby indicating to the submitting user 12 that further populating and/or editing of the document is required prior to approval. It should be appreciated that rejecting a document may further automatically cause one or more notification, such as an email or SMS message, to the submitting user 12 to notify of the rejection of the document. Moreover, action panel 340 includes email and print options, which function substantially similarly to the same options of share panel 328 described above.

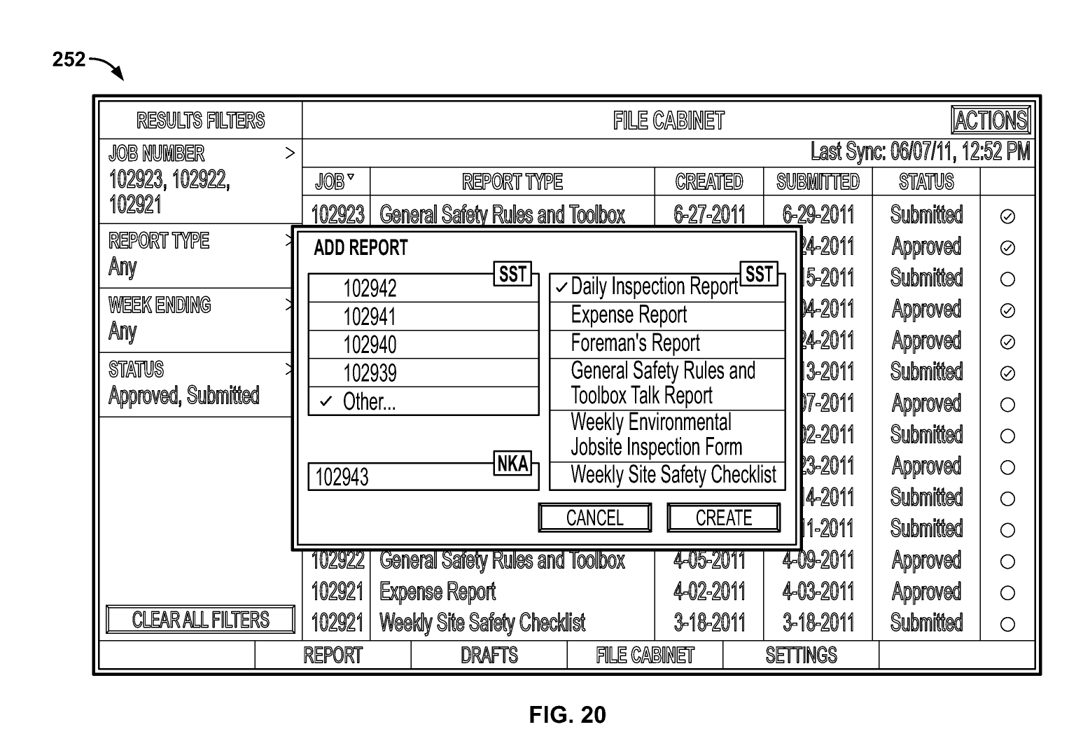

When administrator user 12 selects add report from action panel 340, in FIG. 20, exemplary interface 252 is provided for presentation to administrator user 12. From interface 252, administrator user 12 is permitted to add reports to one or more job sites 108. In the exemplary embodiment, when administrator user 12 adds a document to job site 108, one or more users 12 at job site 108, such as a foreman user 12, is permitted to create, edit, and/or complete the document at portable communication device 104. Accordingly, until administrator user 12 adds the document to the job site 108, users 12 at the job site are not permitted to create the documents. Alternatively, users 12 may be provided sufficient authority to create documents, even when administrator user 12 has not added such documents. In one embodiment, when a document is added by administrator user 12 through interface 252, the document may be automatically created within exemplary interface 202 for user 12 associated with the job site 108.

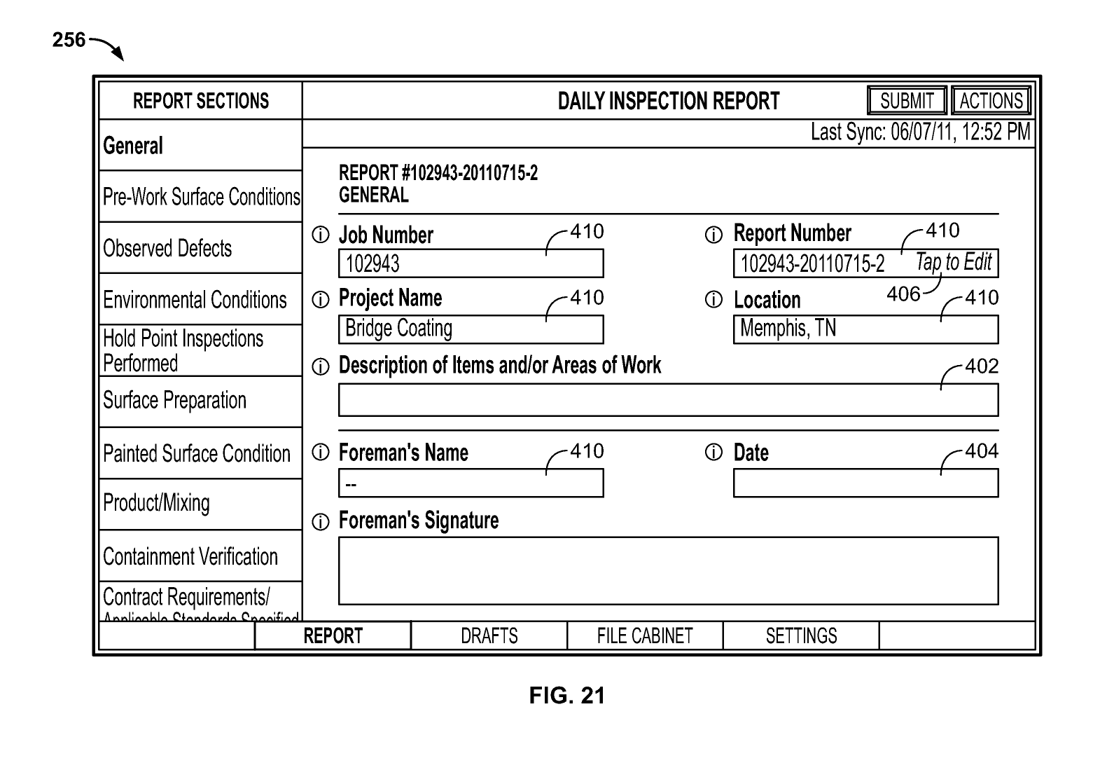

In the exemplary embodiment, exemplary interface 254 of FIG. 21 permits administrator user 12 to manage other users 12 of the administration application. Such users 12 may be created, edited, and/or deleted. As shown, a user type, for example, may be selected to permit the user to access some documents, and to restrict access to other documents. Credentials for one or more users 12 may further be managed from interface 254. The administration application enables levels of security to be provided for each user 12. For example, in one embodiment, the system is created to include a general manager user 12, a project manager user 12, and a foreman user 12. In such an embodiment, general manager user 12 has rights or authority to view, edit, approve, deny, and/or delete any documents created by project manager users 12 and foreman users 12 that are under his direct control. Likewise, project manager user 12 has rights or authority to view, edit, approve, deny, and/or delete any documents created by foreman users 12 that are under his direct control. Accordingly, a hierarchical security system is created that provides users 12 the ability to access information created by users 12 with access levels below them but not access information created by users 12 with access levels above them. In one embodiment, security levels are assigned to users 12 according to job site 108. In such an embodiment, all users 12 at a particular job site 108 are granted the same access to documents associated with the particular job site 1078 within the system irrespective of overall security levels. For example, a job site 108 could grant a foreman user 12 and a general manager 12 the same access to any document associated with job site 108 in which they are associated.

Additionally, user 12 access to the administration application may be conveniently controlled to provide protection of documents accessible through the administration application. In the exemplary embodiment, if a user's portable communication device 104 were lost or user 12 was no longer an employee, administrator user 12 may deactivate and/or delete the user 12 from interface 254 to cut off access under the user's credentials.

Moreover, exemplary interfaces 256 and 258, of FIGS. 21 and 22, include multiple segments of a daily inspection report. In the exemplary embodiment, when accessed by administrator user 12, the type of information entry for each field is selectable to a keyboard 402, radio buttons, a scrolling picker 404, a numeric keyboard 406, a multi-select table 408, an auto-population 410, and a segmented control 412. It should be noted that any type of information entry can be used herein. It should be appreciated that various other controls may be provided to administrator user 12 to create, edit, and/or delete documents within the administration application. Further, while interfaces 250-262 are provided as exemplary part of the administrative module, various other interfaces may be included in the administration application to provide a variety of controls over the administration application, users 12, and/or other aspects of coordinating documentation between job site 108 and host server 102.

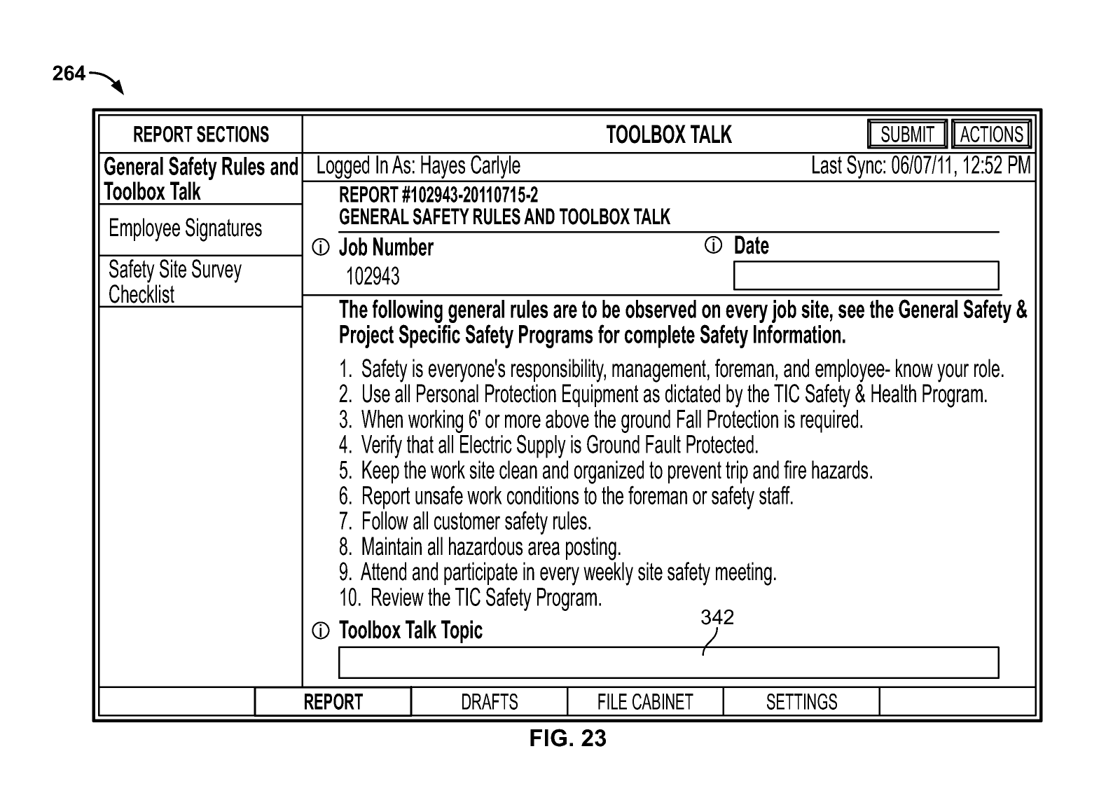

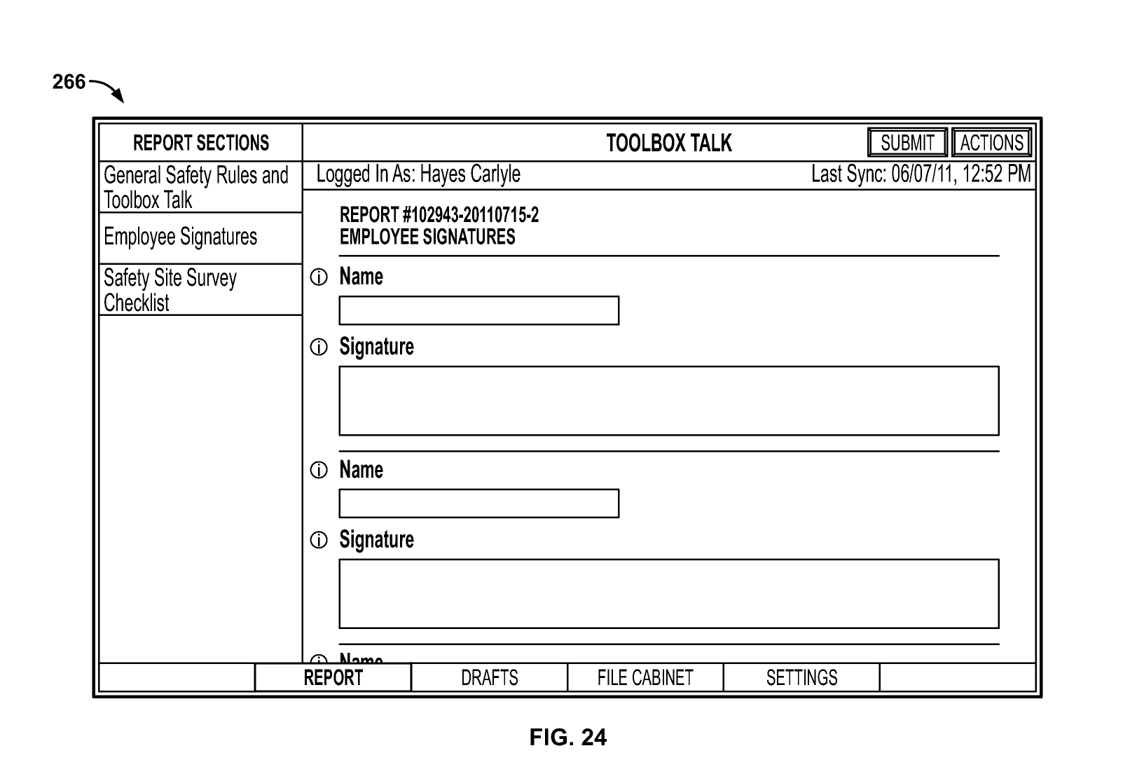

Often, job sites 108 are required to maintain standards of regulatory agencies, such as the Occupational Safety and Health Administration (OSHA), which may require users 12 to attend or participate in safety talks or training. In the exemplary embodiment, in addition to populating documents, system 100 enables users 12 to access content (e.g., video and/or slideshow presentations) and to create a report indicating which users 12 accessed or viewed the content. These reports enable users 12 to satisfy requirements of regulatory and/or individual requirements of job sites 108. Interfaces 264 and 266, as shown in FIGS. 23 and 24, enable portable communications device 104 to access content stored on host server 102 and create a report documenting the access of the content. Field 342 allows user 12 to select content necessary for job site 108. It should be noted that the content can include any information for display, printing, and/or otherwise outputting such as, but not limited to, documents, slideshow presentations, videos, photos, and/or any other type of data. In one embodiment, interface 264 provides photo entry field 310 to capture a photo of user(s) 12 viewing the content. Interface 266 provides a signature field, similar to that shown on interface 230 of FIG. 13, such that the report may be submitted to host server 102 for review and/or approval.

It should be appreciated that interfaces 206-266 are provided as an exemplary embodiment, and should not be considered to limit the scope of the present disclosure. Various different interfaces of an administration application may be employed in other embodiments to perform substantially as described herein, but related to other types of information, different reports, and/or other industries.

The above-described embodiments of a method and system for use in populating at least one document provide a simplified system for creating and maintaining job site documentation. The use of auto-populate fields provides a way to inhibit manual editing of data received by the system and the use of time and geographic tagging provide accountability of the data received. As such, objective results are received and maintained using the above described method and systems.

According to one aspect of the present disclosure, one or more non-transitory computer-readable storage media having computer-executable instructions embodiments thereon is disclosed. When executed by at least one processor, the computer-executable instructions cause the processor to automatically populate the parameter field with the measurement from the sensor disposed at the job site, receive at least one input, and populate another one of the plurality of fields based on the at least one input. According to another aspect of the present disclosure, a method for use in populating information into at least one document is disclosed. The method includes automatically reading, at a portable communication device, a measurement from sensor into a parameter field of a document and populating another one of the plurality of fields based on at least one input.

In one embodiment, technical effects of the methods, systems, and computer-readable media described herein include at least one of: (a) automatically reading, at a portable communication device, a measurement from sensor into a parameter field of a document and (b) populating another one of the plurality of fields based on at least one input.

It should be appreciated that one or more aspects of the present disclosure transform a general-purpose computing device into a special-purpose computing device when configured to perform the functions, methods, and/or processes described herein.

This written description uses examples to disclose various embodiments, which include the best mode, to enable any person skilled in the art to practice those embodiments, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A portable communication device for use in populating information from a job site into at least one document, the portable communication device comprising:
a memory configured to store at least one document, the at least one document including a plurality of fields, the plurality of fields including a parameter field;
an input device configured to receive at least one input from a user;
a communication device configured to receive a measurement provided from a sensor disposed at the job site; and
a processor coupled to the memory and the communication device, the processor configured to automatically populate the parameter field with the measurement received from the sensor disposed at the job site, the processor configured to receive the at least one input and to populate another one of the plurality of fields based on the at least one input.

2. The portable communication device in accordance with claim 1, wherein the processor is further configured to inhibit manual editing of the parameter field.

3. The portable communication device in accordance with claim 1, wherein the processor is further configured to receive a validation parameter including at least one of a time and a geographic location associated with the received at least one input.

4. The portable communication device in accordance with claim 1, wherein the input device includes a touch screen display.

5. The portable communication device in accordance with claim 1, wherein the measurement includes at least one of a temperature, a humidity, a dew point, a wind speed, a wind direction, and a film thickness.

6. The portable communication device in accordance with claim 1, further comprising an image capture device configured to capture an image associated with the job site, and wherein the processor is configured to store the captured image in the at least one document.

7. The portable communication device in accordance with claim 1, wherein the processor is configured to submit the at least one document, when completed, to a host server for review in response to a submit input from the user.

8. The portable communication device in accordance with claim 1, wherein the processor is configured to sync the at least one document with a like document stored in the host server at a predetermined time interval.

9. The portable communication device in accordance with claim 1, wherein the processor is configured to sync the at least one document with a like document stored in the host server at a predetermined event.

10. One or more non-transitory computer-readable storage media having computer-executable instructions embodied thereon, wherein when executed by a controller, the computer-executable instructions cause the controller to:
display at least one document, the at least one document including a plurality of fields, the plurality of fields including a parameter field;
receive at least one input from a user by a portable communication device;
receive, by the portable communication device, a measurement provided from a sensor disposed at the job site;
automatically populate the parameter field with the measurement received from the sensor disposed at a job site; and
populate another one of the plurality of fields based on the at least one input.

11. One or more non-transitory computer-readable storage media according to claim 10, wherein the computer-executable instructions cause the controller to inhibit manual editing of the measurement received in the parameter field.

12. One or more non-transitory computer-readable storage media according to claim 10, wherein the computer-executable instructions cause the controller to receive and record a validation parameter associated with at least one of the received at least one input and the received measurement.

13. One or more non-transitory computer-readable storage media according to claim 10, wherein the computer-executable instructions cause the controller to capture an image associated with the job site, and wherein the processor is configured to store the captured image in the at least one document.

14. One or more non-transitory computer-readable storage media according to claim 10, wherein the computer-executable instructions cause the controller to sync the at least one document with a like document stored in the host server at a predetermined time interval.

15. One or more non-transitory computer-readable storage media according to claim 10, wherein the computer-executable instructions cause the controller to sync the at least one document with a like document stored in the host server at a predetermined event.

16. A document administration system comprising:
a host server, wherein the host server includes a processor and a memory configured to store at least one document;
a portable communication device communicatively coupled to the host server and configured to populate at least one of a plurality of fields within the at least one document; and
a sensor communicatively coupled to the portable communication device, the sensor configured to record a measurement and transmit the measurement to the portable communication device such that the communication device automatically populates a field of the plurality of fields within the at least one document.

17. The document administration system in accordance with claim 16, wherein the processor of the host server is configured to inhibit manual editing of the received measurement.

18. The document administration system in accordance with claim 16, wherein the portable communication device is configured to receive an input from a user and populate at least one of the plurality of fields with the received input from the user.

19. The document administration system in accordance with claim 16, wherein the processor of the host server is configured to record a validation parameter associated with at least one of the received input from a user and the received measurement.
